(19) United States
(12) Patent Application Publication
(10) Pub. No.: US 2026/0027899 A1
(43) Pub. Date: Jan. 29, 2026

(54) Apparatus and Method for Projecting Internal Combustion Engine Vehicle Features in an Electric Vehicle Heads-Up Display

(71) Applicant: Vincent Loccisano, Wellesley, MA (US)

(72) Inventor: Vincent Loccisano, Wellesley, MA (US)

(21) Appl. No.: 18/783,611

(22) Filed: Jul. 25, 2024

(51) Int. Cl. B60K 35/232; B60K 35/28; B60K 35/29; B60K 35/65

(52) U.S. Cl. CPC B60K 35/232; B60K 35/28; B60K 35/29; B60K 35/654; B60K 2360/167; B60K 2360/171; B60K 2360/177; B60K 2360/1868; B60K 2360/21; B60K 2360/48

(57) ABSTRACT

A method and apparatus enables modifying the electronic controls of EVs to mimic the sensory experience of driving a performance ICE car. The method and apparatus creates a sensory “virtual cockpit” by modifying an EV HUD to mimic that of a performance ICE car customized for racing.

### TECHNICAL FIELD

The present disclosure is an apparatus and method related to methods, circuits, or devices for controlling the electronic visual heads-up display of electrically propelled vehicles to achieve a desired performance; information or communication for improving the operation of electric vehicles. The apparatus and method involves arrangements of instruments for, and display of, information in a vehicle, including non-manual adjustments, e.g. with electrical operation with logic circuits and with logic circuits using sensors or detectors for adapting control systems specially adapted for electric vehicles.

### BACKGROUND OF THE INVENTION

While electric vehicles (EVs) and hybrid vehicles offer environmental benefits by reducing greenhouse gas emissions and air pollution, some drivers find the driving experience to be unsatisfactory because there is little sensory feedback of the kind they are used to in traditional internal-combustion-engine (ICE) vehicles. Some consumers express a preference for the visual experience associated with traditional internal-combustion-engine (ICE) vehicles or ICE vehicles adapted for racing, whether out of nostalgia, a perception of a more engaging driving experience, or lack of feedback about vehicle performance in EVs.

Automobile electronics, including computers, electrical cables, and software protocols, are together known as a Controller Area Network (CAN), or CAN bus. A CAN is a vehicle's main computer system. Through the CAN bus, data travels through the system to the many subsystems such as those controlling the engine, the transmission, doors, windows, and other subsystems. Each of these subsystems is controlled by an electronic control unit (ECU). Current EVs may have fifty or more ECUs, each able to sense signals indicating, for example: acceleration at various angles; voltage; pressure; braking; vehicle roll and yaw; steering angle; temperature, and other variables. The CAN bus routes signals from sensors to computers as communicated by each ECU. An ECU can monitor voltage used by a subsystem and communicate that information through the CAN bus to actuate, for instance, stopping a power-sliding door from closing on a passenger's limb, or adjusting a fuel injector's performance.

Adding to or changing a vehicle's electronic features once required extensive wiring. With the development of CAN in the last forty years, feature development (such as adding passenger-controlled climate options) has become physically easier because each new feature can now be added by programming the new computer code into the CAN. Now, all vehicle features as well as vehicle diagnostics are controlled via CAN, which uses a standardized protocol called OBD-II. New features can be integrated into an EV by developing and uploading an algorithm into the vehicle's CAN.

Vehicle computer networks are now evolving to work with other network protocols, including Local Interconnect Networks (LIN) and FlexRay, which are network protocols designed for vehicles, as well as Ethernet.

Modern EV vehicles have software components allowing the suspension, driveline performance, and driver experience to be customizable for a variety of applications. For example, a modern EV may have an “eco” mode that offers greater distance range; a comfort mode that tunes the suspension to be compliant and smooth; and a high-performance mode that offers the best traction, acceleration and cornering performance.

Modern electric drivetrains offer high horsepower and near-instantaneous torque, depending on the size of the car's batteries and number of electric motors. Some EVs have four electric motors, one at each wheel, enabling advanced dynamic control such as torque and power vectoring. Because of this, previously impossible levels of performance, acceleration and speed, as well as control over individual systems, are now available.

The multiple motors of an EV's subsystems enable fine-tuning of vehicle dynamics and performance under braking, acceleration and cornering. Some EVs offer four-wheel steering, with both the front and rear wheels selectively steering in sometimes-different directions. Other controls, including steering ratio, brake-pedal response, accelerator response, horsepower and torque curves are readily changed in a modern EV, simply because they require no more than electronic inputs into the drivetrain and new algorithms downloaded to the vehicle CAN. Shock absorbers and dampers that are electronically controlled can be easily reconfigurable settings. Current computing technology allows implementing variable steering ratios and vehicle performance such as understeer and oversteer.

Multiple electric motors, coupled with brakes with gyroscopic sensors, as well as a variety of other additional existing inputs, allow a vehicle chassis to be actively tuned or reprogrammed. This is possible in existing EVs and will be even more possible as these features are increasingly integrated into the development of future EVs.

Additionally, these modern and near-future electric vehicles have greatly engineered vehicle dynamics, including highly customizable and tunable shock absorbers, roll bars, and dampers. Advanced vehicles also enable remotely adjustable settings for caster, camber, and ride height.

A Heads-Up Display (HUD) is a transparent image projected onto a windshield of a vehicle that presents data without requiring a driver to look away from the road. The origin of the name HUD stems from its earliest application in aircraft where a transparent display in front of the wind screen enabled easier view. A HUD obviates the necessity of refocusing between the landscape and the near surface of the interior dashboard.

Patents and products in the current state of the EV art mimic some of the performance characteristics and exterior sounds of internal-combustion cars. Controls and customizability of the experience are limited and may not be feasible for all vehicle makes and models.

Other inventions delve into haptic feedback systems integrated into the steering wheel or pedals to simulate gear changes or engine response. While these patents address specific aspects of the driving experience, they lack a comprehensive approach to replicating the full sensory experience of an ICE car.

All of these subsystems can be electronically operated through a central control that can be modified by a driver, but the loss of mechanical sound and feel may disappoint driving enthusiasts, who may come to view their EV as an appliance rather than a car.

A customizable and adaptable system that caters to the preferences of car enthusiasts would offer a responsive, sensory experience like that of performance cars.

### SUMMARY OF THE INVENTION

A method and apparatus enables modifying the electronic controls of EVs to mimic the sensory experience of driving a performance ICE car. The method and apparatus creates a sensory “virtual cockpit” by modifying an EV HUD to mimic that of a performance ICE car customized for racing. By downloading and implementing the method and apparatus, one may replicate, for example, the HUD style and graphics used in auto racing. These graphics include a racing line denoting the optimal line to drive through a curve while remaining safely within a lane. The racing line may change color to indicate optimal locations for slowing or braking. For example, a yellow racing line may indicate an optimal location to ease off the accelerator, and a red line may indicate an optimal location in which to brake. Other features of the HUD may project a gauge-indicating traction and general stability by calculating the rpm of each wheel with respect to speed to determine the friction between the tires and the road. A HUD may also project speed, rate of acceleration, distance remaining with current energy level and the like. In some embodiments the HUD is used in conjunction with features to create a virtual experience of driving a performance ICE car, including a tachometer and indicator showing the gear to be used in the ICE at a particular speed. Though not required in an electric motor, such features enhance the experience of driving a performance ICE.

In some embodiments, a software program controls the images projected by a HUD to provide a racing line by receiving information from an EV onboard camera that captures a road ahead of the vehicle. At least one sensor coupled to the vehicle may include a wheel-speed sensor, a speedometer, a GPS signal, a motor-speed sensor, interior temperature sensor, and/or an exterior temperature sensor. A wheel-speed sensor may measure the rotational velocity of each wheel. A speedometer commonly measures the speed of the vehicle over the road. A GPS signal may be used to measure the movement of the vehicle over a mapped area of a road, this result may be compared with information from the speedometer. A motor speed sensor may be used in combination with a wheel-speed sensor, a speedometer and a GPS signal to determine traction or slippage of each wheel. A racing line may be altered to indicate a need for altered steering and braking to indicate an ideal driving line. Images of information gathered from sensors may be projected through the HUD. In some embodiments information gathered from sensors is projected through the HUD, onto the windshield of the vehicle in an image that mimics an image of a related gauge from an ICE performance vehicle. Vehicle speed may be represented by a speedometer from a classic Jaguar vehicle dashboard, for example, or EV voltage may be represented by an ICE performance vehicle gas gauge. Interior or exterior temperature may also be projected through the HUD.

In an example use of the apparatus, a user may upload HUD software to an electric vehicle controller-area network. The software captures an image of the road ahead of the vehicle from an onboard camera and also captures information from at least one sensor. The software compiles information from the camera and sensors to define road parameters including speed, traction and slippage of each wheel, and direction of the vehicle. The compiled information informs the generation of an image of a racing line, also referred to as a driving line, which may be projected on the EV windshield through a HUD. Information from sensors are further used to calculate optimal turning, braking, acceleration through the racing line and the racing line is so updated with color and intensity to reflect a safe and effective driving line.

In another embodiment, the HUD may additionally identify other vehicles on the same road segment and calculate an ideal passing line around said vehicle(s) wherein the passing line is based on calculations of road condition and vehicle dynamic parameters. Dynamic parameters include predicted vehicle traction, current vehicle traction, available acceleration and driver steering, acceleration and braking parameters. The embodiment effectively calculates a way to pass other vehicles in proximity a driver of the electric vehicle. In a similar manner the HUD may provide notifications of required steering inputs in a graphical manner. For example, an obstacle in the road, captured by the EV onboard camera, may engage the software to project a graphical indication of required steering inputs. Steering inputs include, for example, those that indicate to continue straight, steer slightly left, steer forcefully left, steer slightly right, or steer forcefully right. Similarly notifications of acceleration and deceleration inputs may also be projected in a graphical manner. Acceleration or deceleration inputs may include gradual or immediate acceleration, or gradual or immediate deceleration.

The method and apparatus's algorithm may be downloaded into any of an EV's ECUs, CAN, LIN, or Ethernet platform to simulate aspects of an ICE. The method and apparatus creates a virtual cockpit that simulates a particular ICE vehicle, toggling between an EV and ICE experience.

### BRIEF DESCRIPTION OF DRAWINGS

FIG. 1 is a perspective view of the interior of an electric vehicle showing a heads-up display graphic on a windshield.

FIG. 2 is a flowchart of a method of the disclosure.

### DETAILED DESCRIPTION

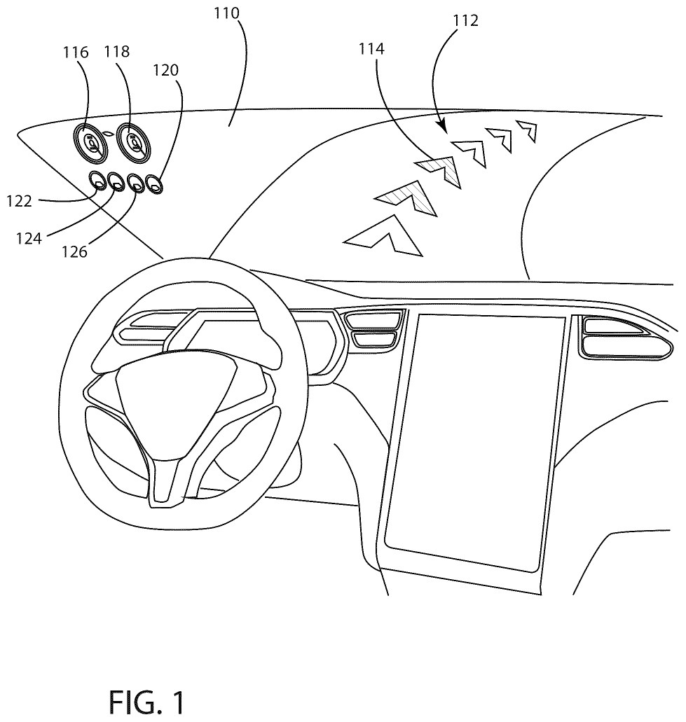

FIG. 1 is a perspective view of the interior of an electric vehicle showing heads-up display graphics on a windshield 110. A racing line 112 denotes the optimal line for driving through a curve. One skilled in the art understands that on public roads, such a feature would produce a line that keeps a driver safely in a lane. The racing line may change color 114 to indicate optimal locations for slowing or braking. For example, a yellow segment of a racing line may indicate an optimal location to ease off the accelerator and a red line segment may indicate an optimal location to brake.

In some embodiments a software program is configured to gather information from EV onboard cameras and sensors to derive information which is projected through the HUD onto the windshield 110 in the style and graphics used in auto racing. For example, a performance ICE vehicle speedometer 116 may depict an animated moving needle showing vehicle speed in MPG or KmPH.

Additional information common to performance ICE vehicles configured for racing may also be projected. In an example embodiment, traction is measured and projected 120. One skilled in the art understands that current EV onboard computers are capable of measuring wheel RPM and calculating circumference distance vs. speed to determine whether wheels are slipping. In another example, energy level 122 may be projected in a graphic style that mimics a performance ICE-vehicle gas gauge. In another example, images of gauges like those in performance ICE vehicles may display rate of acceleration, outside temperature, tire pressure and other metrics in place of an ICE oil-pressure gauge or water-temperature gauge. One skilled in the art understands that the gauges may be reassigned as an EV does not have oil or water coolant to measure.

In another example an ICE-style tachometer 118 is projected through the HUD. Although there is no need for a tachometer 118 in an EV, one skilled in the art understands that the tachometer may show an increase up to a given speed normally associated with first gear, and then a decrease followed by an increase up to a given speed normally associated with second gear, and so on. In yet other embodiments, ICE engine, turbocharger and transmission sounds are played through the EV sound system following the movement of the tachometer.

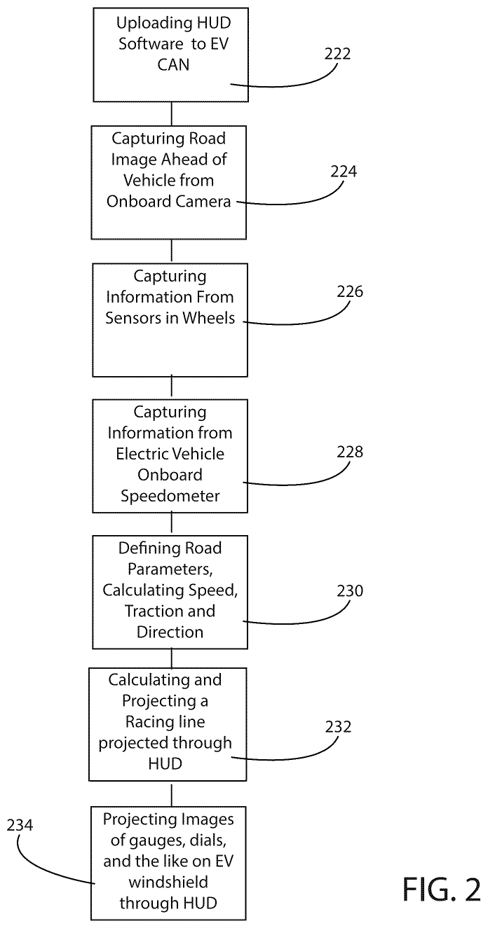

FIG. 2 is a schematic of the method of the disclosure 200. A software program configured to interface with EV onboard cameras and sensors is uploaded to the EV CAN 222 and directs the EV HUD. The software captures a road image from the EV onboard camera 224. Sensors proximal to the wheels of the EV measure rotational velocity of each wheel 226. The speed of the vehicle is measured by the EV onboard speedometer 228. The information gathered and measured is used to calculate speed, traction and direction 230. One skilled in the art understands that the rotational velocity of each wheel, the direction of the vehicle and the direction of a turn in the road may be used to calculate the traction, or slippage, of each wheel. The information gathered is used to inform the software program which then calculates a racing line along the road ahead and projects the racing line 232 on the EV windshield through the heads-up display.

Images of gauges, dials, and the like are projected on the EV windshield through the EV HUD 234. In some embodiments the gauges, dials and the like are rendered images of gauges and dials from ICE performance-vehicle dashboards.

1. A heads-up display for an electric vehicle comprising:
an onboard camera configured to capture a road ahead of the electric vehicle; and
at least one sensor electronically coupled to the vehicle; and
a software program configured to gather information from said onboard camera and said at least one sensor; wherein
the software program defines the parameters of the road ahead of the electric vehicle and the dynamic condition of the vehicle and calculates a racing line along the road ahead of the electric vehicle; and
the at least one sensor is a wheel speed sensor; and
the software program further calculates vehicle tire traction based on data from the wheel-speed sensor; and
the software program further calculates acceleration and braking parameters to follow the racing line; wherein
the racing line and graphical representation of an acceleration region, and braking region are projected on a windshield of the electric vehicle by the heads-up display.

2. The heads-up display of claim 1 wherein:
said software program further gathers information from said onboard camera to identify other vehicles on said road ahead of the electric vehicle to calculate an ideal passing line around said other vehicles; wherein
said passing line is based on calculations of road conditions and vehicle dynamic parameters.

3. The heads-up display of claim 1 wherein:
said heads-up display further provides notification of required steering inputs in a graphical manner.

4. The heads-up display of claim 1 wherein:
said heads-up display provides notifications of required acceleration and deceleration inputs in a graphical manner.

5. The heads-up display of claim 1 wherein:
the software program compares vehicle speed, and the rotational velocity of each wheel to determine if wheels are slipping; wherein
the racing line is altered to indicate a need for altered steering and braking to provide the ideal driving experience.

6. The heads-up display of claim 1 further comprising:
the software program gathers information from the electric vehicle onboard speedometer; and
an image of a speedometer projected onto the windshield of the electric vehicle through the heads-up display.

7. The heads-up display of claim 6 wherein:
the image of the speedometer is an image of an ICE performance vehicle speedometer.

8. The heads-up display of claim 1 further comprising:
the software program gathers information from the electric vehicle onboard battery meter; and
an image of a battery meter is projected onto the windshield of the electric vehicle through the heads-up display.

9. The heads-up display of claim 8 wherein:
the image of the battery meter is an image of an ICE performance vehicle gas gauge.

10. The heads-up display of claim 1 further comprising:
the software program gathers information from the electric vehicle onboard temperature gauge; and
an image of inside and outside temperature is projected onto the windshield of the electric vehicle through the heads-up display.

11. The heads-up display of claim 10 wherein:
the image of the temperature gauge is an image of an ICE performance vehicle temperature gauge.

12. A method of performing the functions of the apparatus of claim 1, the method comprising:
uploading heads-up display software to electric vehicle controller-area network; and
capturing road image ahead of a vehicle from an onboard camera; and
capturing information from sensors in communication with the vehicle's electronic control unit; and
defining road parameters including speed, traction and direction; and
calculating and projecting a racing line through the heads-up display.

13. The method of claim 12 further comprising:
projecting images of electric vehicle gauges through the heads-up display.

14. The method of claim 13 wherein:
the images of electric vehicle gauges mimic the appearance of ICE performance vehicle gauges.
